(19) United States
(12) Patent Application Publication
(10) Pub. No.: US 2010/0298962 A1
(43) Pub. Date: Nov. 25, 2010

(54) INFORMATION PROCESSING APPARATUS, MANUFACTURING APPARATUS, AND DEVICE MANUFACTURING METHOD

(75) Inventor: Daichi TAKAHASHI, Utsunomiya-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/787,129

(22) Filed: May 25, 2010

(30) Foreign Application Priority Data
May 25, 2009 (JP) 2009-125846

(51) Int. Cl. G06F 19/00

(52) U.S. Cl. 700/103

(57) ABSTRACT

An apparatus for updating control information of a manufacturing apparatus comprises: a storage configured to store consistency information indicating a consistency between a configuration of a manufacturing apparatus and control information and result information indicating a result of installing of control information in the manufacturing apparatus in association with each other; and a computer configured to execute, prior to updating of control information installed in the manufacturing apparatus with new control information, a determination as to whether the manufacturing apparatus which receives an instruction of the updating normally operates after the updating, based on the consistency information and the result information stored in the storage, and to update the control information installed in the manufacturing apparatus with the new control information if the determination is positive.

### BACKGROUND OF THE INVENTION

1. Field of the Invention

The present invention relates to an information processing apparatus, manufacturing apparatus, and method of manufacturing a device.

2. Description of the Related Art

Manufacturing apparatus used to manufacture various products have gained enhanced performances and advanced functions according to performance and function enhancements of those products. For example, taking manufacturing apparatus of, for example, semiconductor devices and liquid crystal panels such as integrated circuits and large-scale integrations as examples, the precisions and functions of exposure apparatus used in productions of semiconductor devices have enhanced as these products are miniaturized and their degrees of integration become higher. As such exposure apparatus, apparatus called a stepper and scanner are normally used. Each of these apparatus sequentially transfers a pattern formed on a master plate (e.g., a reticle) on a plurality of positions of a substrate (e.g., a semiconductor wafer) while moving the substrate step by step. An apparatus that performs these transfer processes simultaneously is called a stepper, and that which transfers a pattern while scanning a stage is called a scanner. In recent years, in order to meet two requirements, that is, superposition precision and throughput as important performances of an exposure apparatus, an exposure apparatus which mounts two substrate stages for holding substrates is put into practical use. Also, development of an exposure apparatus which attains high-resolution transfer by filling a liquid between a projection optical system used to project a pattern of a master plate and a substrate is in progress.

While the precision and function enhancements of manufacturing apparatus represented by exposure apparatus are in progress in this way, software required to control a manufacturing apparatus is also upgraded as needed to attain precision and function enhancements. Such upgraded software can often be applied not only to new apparatus to be developed but also to already operating manufacturing apparatus. Software of operating manufacturing apparatus is updated (upgraded) frequently.

As an example of updating of software in a conventional manufacturing apparatus, the sequence for updating software of an exposure apparatus will be described below with reference to FIG. 18. The hardware configuration and required functions of the exposure apparatus are checked in advance to decide a version of software to be applied (S4001). Next, a medium which stores control information including required software and data associated with the software is prepared (S4002). After steps S4001 and S4002 are executed in advance, an exposure process of the exposure apparatus whose control information such as software is to be updated is stopped in step S4003. As an example of an installation location of an exposure apparatus, a semiconductor device manufacturing plant or place (to be referred to as a semiconductor device manufacturing plant 7 hereinafter) as a manufacturing location of semiconductor devices will be briefly described below. The semiconductor device manufacturing plant 7 includes a first communication network 6 such as a local area network, and a controller 3 of the manufacturing plant, for example, schedules exposure apparatus 1 and another manufacturing apparatus 2 (e.g., process apparatus).

In step S4003, the exposure process of the exposure apparatus 1 of interest is stopped by stopping an exposure process request from controller 3 to exposure apparatus 1. In step S4004, control information of the exposure apparatus 1 is updated. More specifically, the control information is updated in such a manner that an operator inserts a medium such as a magneto-optical disk or floppy disk which stores control information such as software into the exposure apparatus 1, and makes operations for, for example, setting update conditions and copying the control information. Please refer to Japanese Patent Laid-Open No. 11-296352.

After software is updated, a control unit of the exposure apparatus 1 is restarted to reflect the control information. Finally, the exposure apparatus 1 after the control information is updated is tested in step S4005. If no problem is found in the test in step S4005, the exposure process is started in step S4006.

On the other hand, a proposal for updating control information such as software of the exposure apparatus 1 using a communication network such as the Internet or a local area network has been made. For example, the controller 3 of the manufacturing plant described using FIG. 19 updates control information such as software of each exposure apparatus 1 via the first communication network 6 of the semiconductor device manufacturing plant 7. Please refer to Japanese Patent Laid-Open No. 2000-188252.

Updating of software of the manufacturing apparatus is a method that allows even an operating apparatus to enhance its precision and functions, and is effective in improving the productivity of the manufacturing apparatus.

As described above, improving the precision and function enhancements of a manufacturing apparatus by updating software is an effective method for improving operating apparatus productivity. In this software updating process, the hardware configuration and required functions of an exposure apparatus have to be checked in advance to decide the version of software to be applied (step S4001 in FIG. 18). Conventionally, this pre-checking process is a simple operation since there are small options of software. However, in recent years, a manufacturing apparatus and software required to control the apparatus are complicated, and it takes much time to select software to be applied. As described in the paragraphs of the related arts, as the performances and functions of various products are enhancing, the performance and function enhancements of manufacturing apparatus used to manufacture them are also progressing. Accordingly, many options are available for the manufacturing apparatus, and there are many versions of software in correspondence with these options. The software itself becomes enormous as it gains advanced functions, and a method of controlling a manufacturing apparatus by combining a plurality of software programs is prevalent. For this reason, the number of required software programs is increasing. For example, in an exposure apparatus as an example of a manufacturing apparatus, an option which selects exposure light to fit the intended use of the user, and that that selects a substrate carry-in position in the apparatus according to the installation location of the exposure apparatus are available, and corresponding software programs are prepared. The software itself includes an option that speeds up processing by optimizing a control method in correspondence with the user's operations. In the situation in which the manufacturing apparatus and software required to control the apparatus are complicated, a target version has to be selected from many versions of many software programs in consideration of the configuration of an apparatus to be upgraded. If a wrong version is selected, the manufacturing apparatus cannot be upgraded, and is wastefully stopped.

On the other hand, it is a common practice to use manufacturing apparatus such as exposure apparatus all day long without stopping them since they are production equipments required to manufacture products. For this reason, a downtime as an operating time other than manufacturing processes such as a maintenance time influences the productivity of the user. The software updating is also effective to improve the productivity in the long term. However, during updating of the software, the processes of the manufacturing apparatus have to be stopped, thus temporarily decreasing the productivity. As described above, when a wrong version to be upgraded is selected, the productivity is further decreased. Hence, it is demanded to select the version of software to be upgraded by an easier and safer method.

### SUMMARY OF THE INVENTION

The present invention provides, for example, an information processing apparatus advantageous in updating of control information of a manufacturing apparatus.

According to the present invention, there is provided an information processing apparatus for updating control information of a manufacturing apparatus, the apparatus comprising: an updating unit configured to update control information installed in the manufacturing apparatus with new control information; and a determination unit configured to execute a first determination as to whether there is a consistency between a configuration of the manufacturing apparatus and the new control information based on consistency information indicating a consistency between a configuration of a manufacturing apparatus and control information, to execute a second determination, if the first determination is not negative, as to whether the manufacturing apparatus normally operates after the new control information is installed therein, based on result information indicating a result of installing of a control information in a manufacturing apparatus, and to instruct the updating unit, if the second determination is not negative, to update the control information installed in the manufacturing apparatus with the new control information.

Further features of the present invention will become apparent from the following description of exemplary embodiments with reference to the attached drawings.

### BRIEF DESCRIPTION OF THE DRAWINGS

FIG. 1 is a diagram of a manufacturing system according to the first embodiment;

FIG. 2 is a diagram of an updating unit;

FIG. 3 is a diagram of an exposure apparatus;

FIG. 4 is a diagram of a control unit in the exposure apparatus;

FIG. 5 is a table showing a configuration information list;

FIG. 6 is a diagram of a determination unit;

FIG. 7 is a table showing consistency information;

8A to 8D in FIG. 8 are tables showing some pieces of consistency information;

9A to 9D in FIG. 9 are tables showing some pieces of result information;

FIG. 10 is a table showing a list of test results;

FIG. 11 is a diagram of an exposure unit;

FIG. 12 is a flowchart of a method of updating control information of the exposure apparatus according to the first embodiment;

FIG. 13 is a flowchart of a method of confirming a consistency according to the first embodiment;

FIG. 14 is a flowchart of a method of confirming a result according to the first embodiment;

FIG. 15 is a view showing an example of an operation screen displayed upon updating control information of the exposure apparatus;

FIG. 16 is a flowchart of a method of updating control information of an exposure apparatus according to the second embodiment;

FIG. 17 is a diagram of a manufacturing system according to the third embodiment;

FIG. 18 is a flowchart of a conventional method of updating control information of an exposure apparatus; and

FIG. 19 is a diagram of a conventional manufacturing system.

### DESCRIPTION OF THE EMBODIMENTS

### First Embodiment

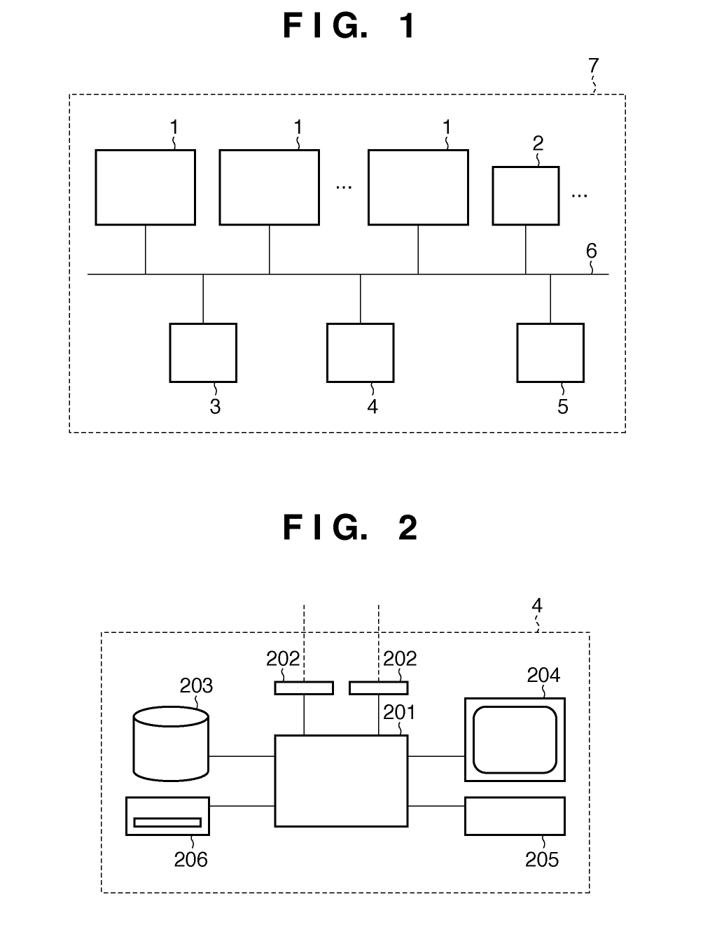

The first embodiment of an information processing apparatus, which can update control information including at least one of software required to control a manufacturing apparatus according to the present invention, and data associated with the software will be described below. FIG. 1 is a diagram of a manufacturing system including exposure apparatus as manufacturing apparatus. This embodiment will explain a manufacturing system installed in a semiconductor device manufacturing plant 7 as a plant or place as a semiconductor device manufacturing location. In the semiconductor device manufacturing plant 7, one or more exposure apparatus 1 and another manufacturing apparatus 2 are laid out. The one or more exposure apparatus 1 and other manufacturing apparatus 2 are connected to a controller 3 of the manufacturing plant via a first communication network 6 such as a local area network of the semiconductor device manufacturing plant 7. The controller 3 controls the exposure apparatus 1 and other manufacturing apparatus 2 to produce semiconductor devices.

An updating unit 4 stores control information including software required to control each exposure apparatus 1 and data such as parameters associated with the software (to be simply referred to as “control information” hereinafter). The updating unit 4 is connected to the one or more exposure apparatus 1 via the first communication network 6, and updates (upgrades) the control information installed in each exposure apparatus 1 by new control information. The updating unit 4 is further connected to a determination unit 5 via the first communication network 6. The updating unit 4 and determination unit 5 configure an information processing apparatus used to update the control information.

The determination unit 5 performs a first determination as to whether or not to update the control information of each exposure apparatus 1 by collating the version of control information acquired from the updating unit 4 and configuration information acquired from that exposure apparatus 1 with consistency information which is stored in advance. Note that details of a method of determining the advisability of updating of the control information based on collation with consistency information will be described later. Also, the determination unit 5 collates the version of the control information acquired from the updating unit 4 and the configuration information acquired from the exposure apparatus 1 with previous result information which is stored in advance. The result information indicates an installation result of control information in each exposure apparatus 1 whose control information to be updated, or another exposure apparatus 1 which belongs to the same group as that exposure apparatus 1. Based on this collation result, the determination unit 5 performs a second determination as to whether or not to update the control information of the exposure apparatus 1. Note that a method of determining the advisability of updating of the control information based on collation with the result information will be described later. Thus, the updating unit 4 can update control information based on the results of the determinations about the advisability of updating of the control information made by the determination unit 5 as well as the previous results. In this embodiment, the determination unit 5 stores the consistency information and result information. Alternatively, a storage unit independent of the determination unit 5 may store the consistency information and result information. The independent storage unit is, for example, a storage unit which stores consistency information and result information.

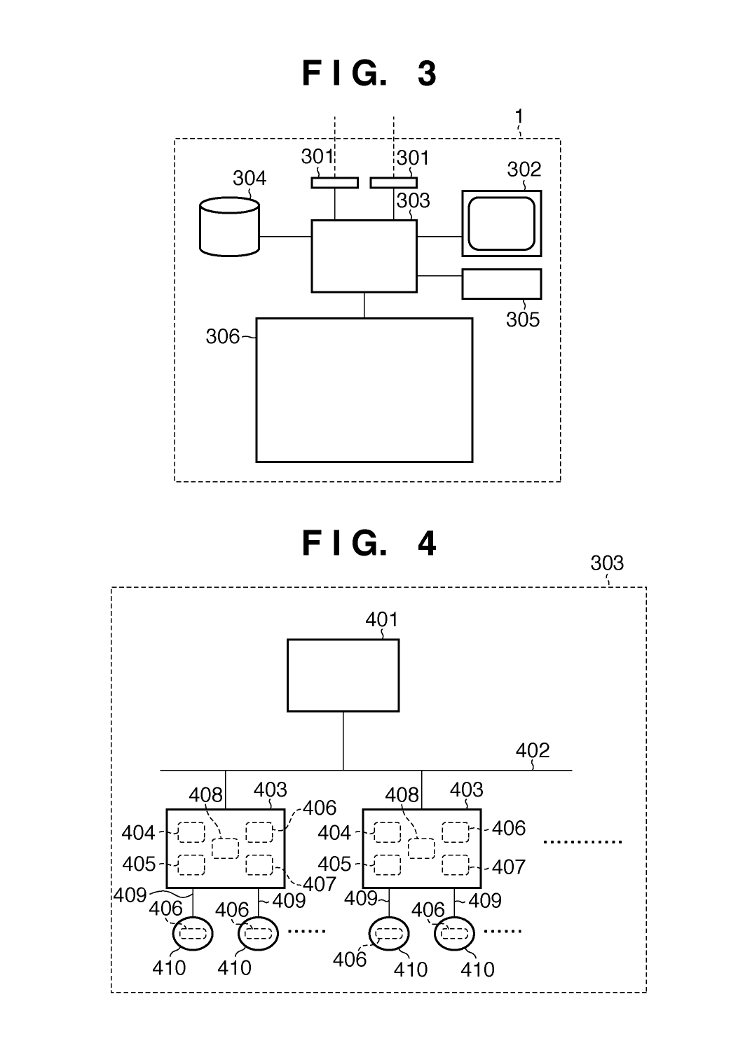

The updating unit 4 will be described below. FIG. 2 is a diagram showing an example of the updating unit. The updating unit 4 includes a first control unit 201, one or more first communication units 202, first storage unit 203, first display unit 204, first operation unit 205, and recording media reading unit 206. For example, the first control unit 201 can be implemented by a known computer or board computer. The first communication unit 202 can be implemented by a known communication board. The first storage unit 203 can be implemented by a known hard disk. The first display unit 204 can be implemented by a known monitor. The first operation unit 205 can be implemented by a known keyboard and the like. The recording media reading unit 206 can be implemented by a known recording media reader/writer for, for example, a magneto-optical disk. The first storage unit 203 stores control information. The first control unit 201 can update (e.g., upgrade) control information of the exposure apparatus by transferring control information pre-stored in a recording medium inserted into the recording media reading unit 206 to the exposure apparatus 1 using one of the first communication units 202. Note that the control information need not be pre-stored in the recording medium inserted into the recording media reading unit 206. For example, control information may be externally transferred to the first storage unit 203 using one of the first communication units 202, and may then be transferred to the exposure apparatus 1 to update the control information. When the consistency information and result information are stored in a storage unit independent of the determination unit 5 such as a storage unit, the updating unit 4 and determination unit 5 may be configured by a single computer.

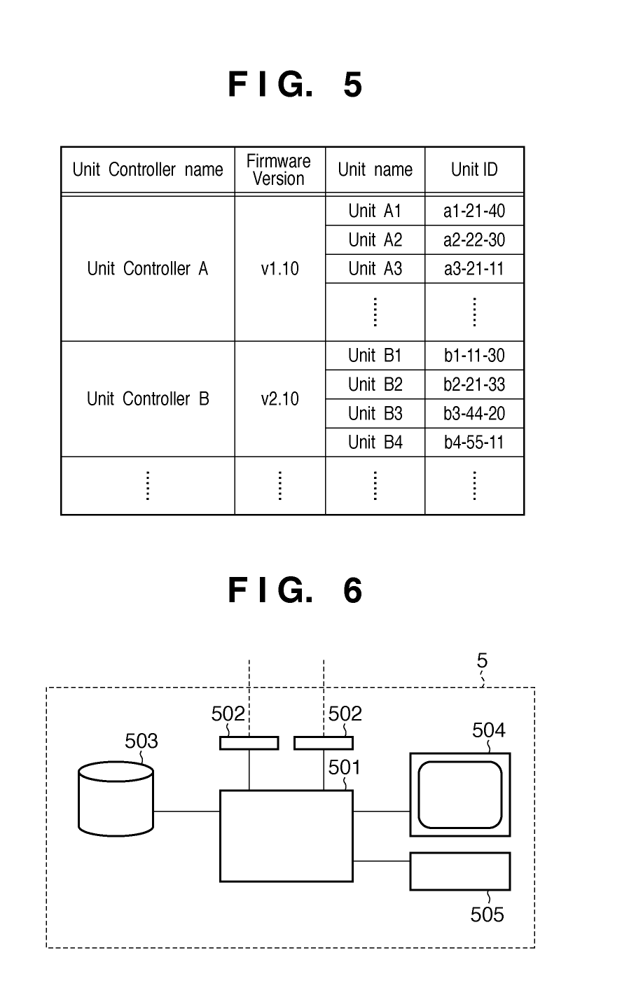

The exposure apparatus 1 which exposes a substrate via a reticle pattern will be described below. FIG. 3 is a diagram showing an example of the exposure apparatus. The exposure apparatus 1 includes one or more second communication units 301, a second display unit 302, control unit 303, second storage unit 304, second operation unit 305, and exposure unit 306. For example, the second display unit 302 can be implemented by a known monitor, and the second operation unit 305 can be implemented by a known keyboard and the like. The control unit 303 of the exposure apparatus 1 controls the exposure unit 306, and further includes one or more unit controllers 403 which are connected via a control system communication network 402 to have a main control unit 401 as a core, as will be described later. The control unit 303 controls the exposure unit 306 according to control information stored in the second storage unit 304. An example of the second storage unit 304 is a hard disk as an external storage, which saves software and data using a database system. An example of each second communication unit 301 is a known communication interface board, and the control unit 303 can communicate with the updating unit 4, determination unit 5, and the like via the second communication units 301.

The control unit 303 of the exposure apparatus 1 will be described below with reference to FIG. 4. The control unit 303 includes the main control unit 401, the control system communication network 402, one or more unit controllers 403, and one or more units 410. The main control unit 401 performs central control of the unit controllers 403 connected via the control system communication network 402, and can be implemented by, for example, a known computer or board computer. The control system communication network 402 communicates with the one or more unit controllers under the control of the main control unit 401 via known communication interface boards included in, for example, the main control unit 401 and unit controllers 403. The control system communication network 402 may adopt a prevalent general-purpose communication standard. However, in order to meet requirements such as realtimeness unique to a control system, the control system communication network 402 normally adopts a communication standard having realtimeness.

Each unit controller 403 interprets a control instruction sent from the main control unit 401 via the control system communication network 402, and performs control according to the control instruction for the one or more units 410 connected to that unit controller 403. The unit controller 403 includes a CPU 408 which interprets unit control programs, a memory 404 which temporarily stores the unit control programs and data, and a unit control program storage unit 405 which stores the unit control programs required to have nonvolatility. Furthermore, the unit controller 403 includes a unit control program version storage unit 407 which stores the versions of the unit control programs. Moreover, the unit controller 403 includes a unit ID storage unit 406 which stores an identification number to be updated upon changing hardware that configures the unit controller (to be simply referred as “unit ID” hereinafter). In addition, the unit controller 403 includes control lines 409 used to control the units. The unit ID can include hardware settings and adjustment logs when it is changed upon changing the hardware, and is changed upon changing the hardware settings using dip switches and upon adjustment of the hardware. For example, the unit controller 403 can be implemented by a control board including an integrated microcomputer LSI and peripheral circuit. In this case, the CPU 408 can be implemented by a known CPU incorporated in the microcomputer LSI. The memory 404 can be implemented by a memory incorporated in the microcomputer LSI or a known external memory connected to a microcomputer LSI external bus. The unit control program storage unit 405 can be implemented by a programmable ROM incorporated in the microcomputer LSI or a known external programmable ROM connected to the microcomputer LSI external bus. The unit ID storage unit 406 can be implemented by a programmable ROM incorporated in the microcomputer LSI or a known external programmable ROM connected to the microcomputer LSI external bus. The unit control program version storage unit 407 can be implemented by a programmable ROM incorporated in the microcomputer LSI or a known external programmable ROM connected to the microcomputer LSI external bus. Each control line 409 can be implemented by a serial/parallel port which is to undergo I/O control by a microcomputer LSI internal controller or a peripheral controller connected to the microcomputer LSI external bus. Note that the unit control program storage unit 405, unit ID storage unit 406, and unit control program version storage unit 407 may use either an identical programmable ROM or independent programmable ROMs. However, the unit ID storage unit 406 is desirably implemented by an independent programmable ROM so as to prevent the unit ID from being inadvertently rewritten upon updating of the unit control program. A unit 410 which does not include any unit ID storage unit 406 may be substituted in such a manner that identification information equivalent to a unit ID may be stored in a certain area of the unit ID storage unit 406 included in the unit controller 403, and may be rewritten in synchronism with a change of the unit 410. The unit 410 is a generic term of a series of sensors, actuators, and the like to be controlled by the unit controller 403 (they will be simply referred to as “unit” hereinafter). Each unit 410 can include a unit ID storage unit 406 as in the unit controller 403.

The control unit 303 of the exposure apparatus 1 to which the present invention is applied is provided with a function of collecting configuration information of the apparatus required to collate consistency information associated with updating of control information. The configuration information includes a unit ID of each unit 410, that of each unit controller 403, and the versions of the unit control programs included in each unit controller 403 (they will be simply referred to as “configuration information” hereinafter).

Immediately after the control unit 303 of the exposure apparatus 1 is started up or when a request is received from the main control unit 401, each unit controller 403 reads out unit IDs from the units 410 having unit IDs via the control lines 409. Then, the unit controller 403 forms a unit ID list including pairs of readout unit names and unit IDs, and temporarily stores the list in the memory 404. Furthermore, the unit controller 403 reads out the unit ID of itself from the unit ID storage unit 406, and the readout unit ID can be included in the unit ID list. When the unit 410 which does not have any unit ID is substituted by the unit ID storage unit 406 included in the unit controller 403, the unit controller 403 reads out the unit ID of that unit 410 from there, and the readout unit ID can be included in the unit ID list. The main control unit 401 receives the unit ID lists from the respective unit controllers 403 via the control system communication network 402. Furthermore, the main control unit 401 receives the versions of the unit control programs from the respective unit controllers 403 via the control system communication network 402. Finally, the main control unit 401 configures configuration information including the unit ID lists and the versions of the unit control programs acquired from the unit controllers 403 to be paired with the names of the unit controllers 403. Furthermore, the main control unit 401 stores the configured configuration information in the second storage unit 304.

FIG. 5 is a table showing an example of a data structure of the configuration information. FIG. 5 expresses the configuration information in a table format, which is called a configuration information list. The configuration information list in FIG. 5 can be created, edited, and referred to using, for example, a known relational database management system pre-stored in the second storage unit 304. A first column “Unit Controller name” in the configuration information list shown in FIG. 5 enumerates names of all the unit controllers 403 included in the control unit 303 of the exposure apparatus. A second column “Firmware version” enumerates the versions of the unit control programs of the unit controllers 403 corresponding to the names in the first column. A third column “Unit name” enumerates the names of the units 410 controlled by the unit controllers 403 corresponding to the names in the first column. A fourth column “Unit-ID” enumerates the unit IDs of the units 410 corresponding to the names in the third column. Note that the two columns, that is, the third and fourth columns correspond to the unit ID lists including pairs of the unit names and unit IDs.

The determination unit 5 will be described below with reference to FIG. 6. The determination unit 5 includes a third control unit 501, one or more third communication units 502, third storage unit 503, third display unit 504, and third operation unit 505. The third control unit 501 can be implemented by, for example, a known computer or board computer. Each third communication unit 502 can be implemented by, for example, a known communication interface board. The third storage unit 503 can be implemented by, for example, a known hard disk. The third display unit 504 can be implemented by, for example, a known monitor. The third operation unit 505 can be implemented by, for example, a known keyboard and the like. The determination unit 5 stores, in the third storage unit 503 in advance, consistency information associated with updating of control information, and result information including results of tests in case examples in which identical control information was previously updated, and operation logs periodically acquired after operations. The determination unit 5 also stores, in the third storage unit 503, a consistency confirmation program required to confirm a consistency based on consistency information, and a result confirmation program required to make confirmation based on result information.

Details of consistency information will be described below. The consistency information includes the following two pieces of information:

1. information (an inter-module dependence list to be described later) which indicates the presence/absence of “dependence” as a condition (a combination of versions or unit IDs) between modules (to be described later) required when the exposure apparatus operates; and

2. information (a compatibility table to be described later) which indicates details of dependences and indicates the presence/absence of “compatibility” indicating if the exposure apparatus is operable under respective conditions (combinations of versions or unit IDs) between modules.

The modules will be explained below while being classified into hardware modules and software modules. The hardware modules and software modules are units required to manage hardware and software. The hardware modules include the units 410 having the unit IDs and the unit controllers 403. The software modules are units obtained by dividing the control information for respective functions, and a minimum unit is, for example, a file. Each software module further includes a plurality of software modules as sub-modules, and can be configured as a larger unit. Also, the above phrase “between modules” indicates both “between at least one hardware module and at least one software module”, and “between at least two software modules”.

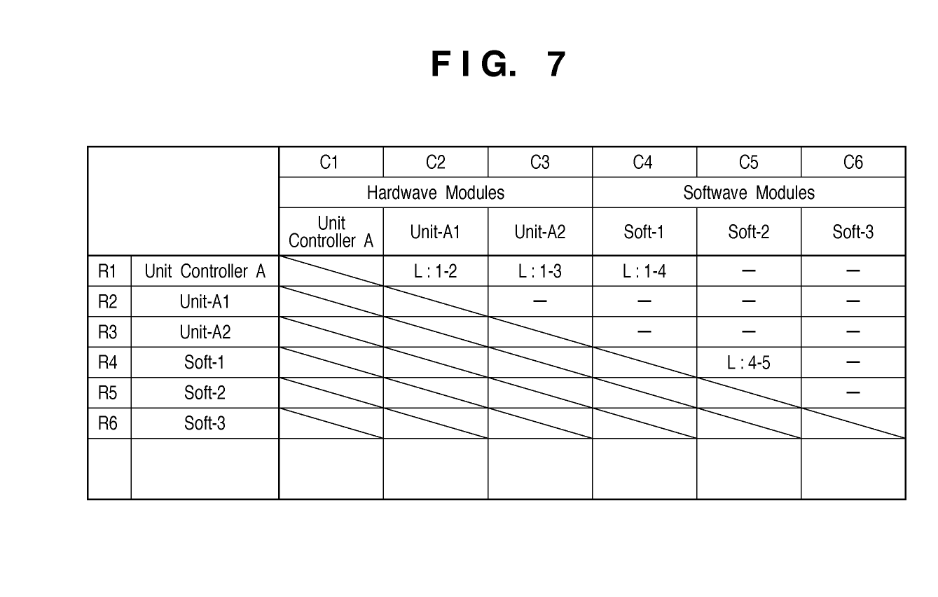

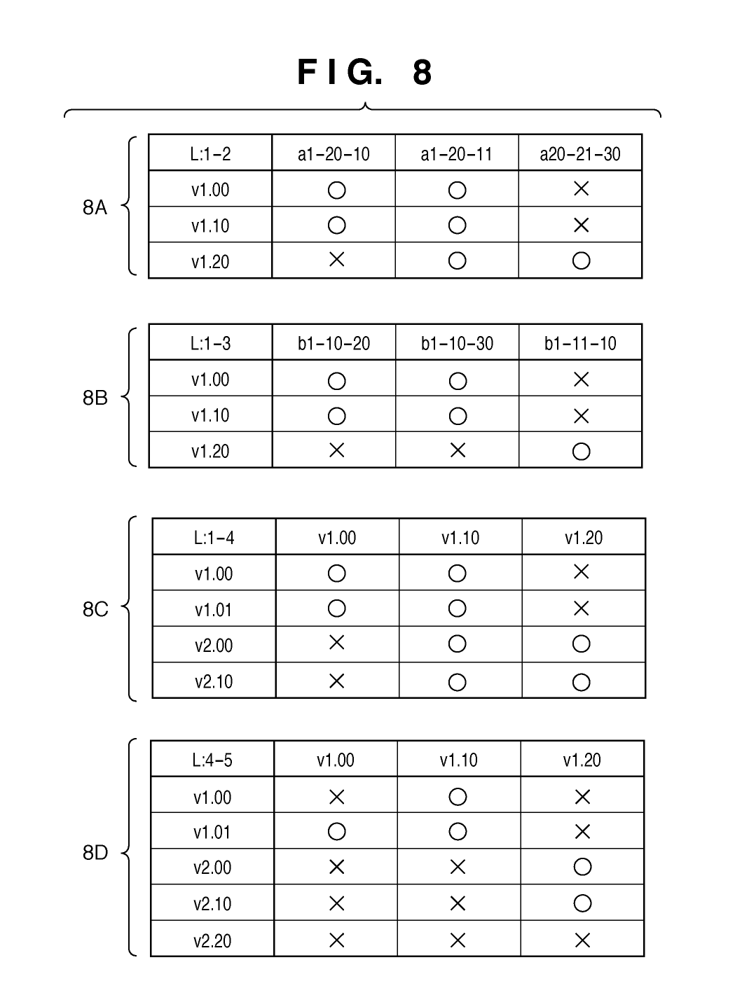

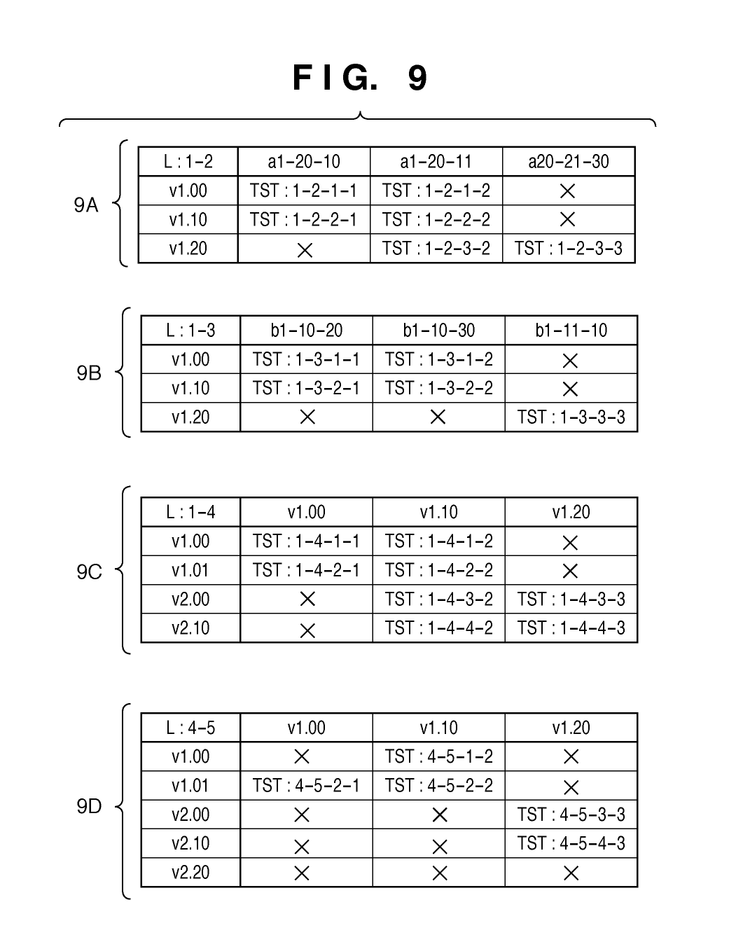

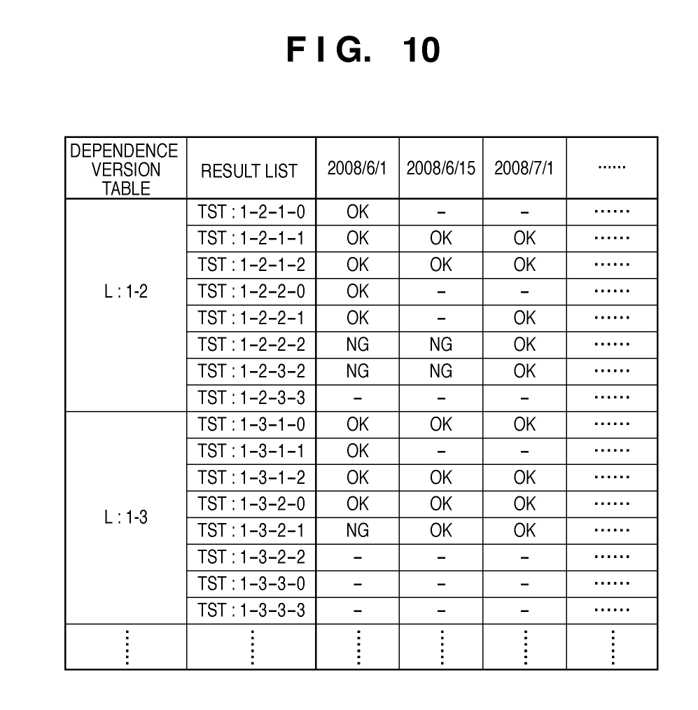

FIGS. 7 and 8A to 8D in FIG. 8 show an example of the data structure of the consistency information. FIG. 7 shows an inter-module dependence list, which indicates the presence/absence of inter-module dependences in a table format. The inter-module dependence list can be created, edited, and referred to using, for example, a known relational database management system pre-stored in the third storage unit 304. FIG. 7 is configured by a table having the number of columns/the number of rows as many as the total number of modules, and fields for respective modules are assigned to rows/columns. In the table shown in FIG. 7, the number of columns is represented by Cmax, the number of rows is represented by Rmax, the i-th row (to be referred to as an “i-row” hereinafter) is represented by Ri, the j-th column (to be referred to as “j-column” hereinafter) is represented by Cj, and a field specified by the i-row and j-column is represented by RiCj. When a dependence is present between a module corresponding to the i-row (to be referred to as “module-i” hereinafter), and a module corresponding to the j-column (to be referred to as “module-j” hereinafter), a label “L:i-j” to a compatibility table, which indicates details of the dependence, is set in RiCj. When no dependence is present, “-” is described. Also, hatched fields in FIG. 7 indicate redundant combinations, and their descriptions are omitted. In the example of FIG. 7, there is a dependence between a unit controller “Unit Controller-A” assigned to R1 and a unit “Unit-A1” assigned to C2, and a label “L:1-2” to a corresponding compatibility table is set. Likewise, there is a dependence between the unit controller “Unit Controller-A” assigned to R1 and a unit “Unit-A2” assigned to C3, and a label “L:1-3” to a corresponding compatibility table is set. Likewise, there is a dependence between the unit controller “Unit Controller-A” assigned to R1 and a software module “Soft-1” assigned to C4, and a label “L:1-4” to a corresponding compatibility table is set. Likewise, there is a dependence between a software module “Soft-1” assigned to R4 and a software module “Soft-2” assigned to C5, and a label “L:4-5” to a corresponding compatibility table is set. When the inter-module dependences are expressed, as shown in FIG. 7, all fields which meet a relation Ci>Ri can cover the presence/absence of inter-module dependences in all combinations of all modules.

8A, 8B, 8C, and 8D in FIG. 8 show compatibility tables indicating details of dependences between the modules having the dependences. The compatibility tables are set for respective labels “L:i-j” in 8A to 8D in FIG. 8. Respective versions or unit IDs of modules-i are assigned to rows, and respective versions or unit IDs of modules-j are assigned to columns. Each field indicates whether or not a module-i having a corresponding version or unit ID and a module-j having a corresponding version or unit ID form a combination that allows the exposure apparatus to operate (compatibility). In 8A to 8D in FIGS. 8, a combination that allows the exposure apparatus to operate (presence of compatibility) is expressed as ◯, and a combination that does not allow the apparatus to operate (absence of compatibility) is expressed as x. In this embodiment, 8A in FIG. 8 shows the compatibility table referred to by the label “L:1-2” in FIG. 7 above, and enumerates all versions of “Unit Controller-A” assigned to R1 as “rows”. Also, 8A in FIG. 8 enumerates all unit IDs of “Unit-A1” assigned to C2 as “columns”. Furthermore, in 8A in FIG. 8, the presence/absence of compatibility in each of combinations of their versions and unit IDs is set. Likewise, 8B in FIG. 8 shows the compatibility table referred to by the label “L:1-3” in FIG. 7 above. 8C in FIG. 8 shows the compatibility table referred to by the label “L:1-4” in FIG. 7. 8D in FIG. 8 shows the compatibility table referred to by the label “L:4-5” in FIG. 7. The consistency confirmation program collates a consistency between configuration information acquired from the exposure apparatus 1 and control information acquired from the updating unit 4 based on consistency information stored in the third storage unit 503, and determines whether or not to update the control information. The result information includes test results in case examples of previous applications of control information to be updated, and operation logs periodically acquired after operations. As the result information, a test result and operation log are stored in the third storage unit 503 as a set together with version information for each software module. Furthermore, as the result information, when modules have a dependence between them, a test result and operation log in that combination are stored in the third storage unit 503 as a set together with their versions (or unit IDs) and consistency information.

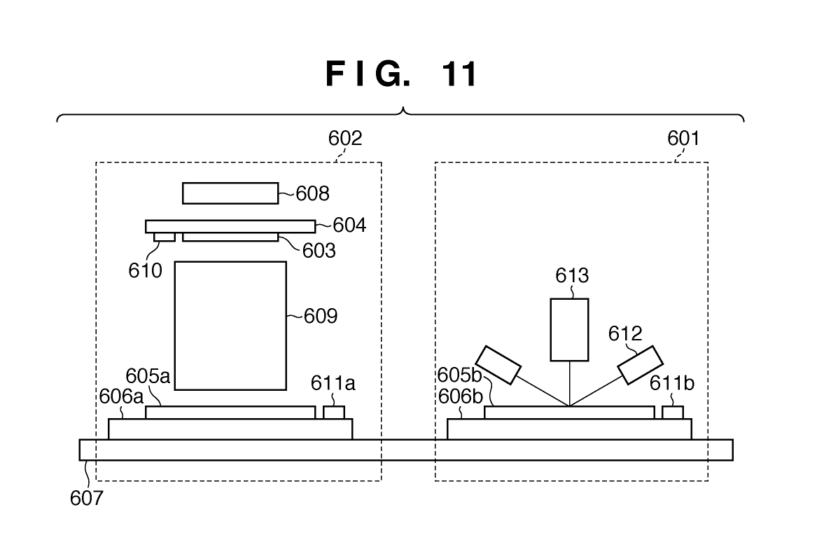

9A to 9D in FIG. 9 and FIG. 10 show an example of the data structure of the result information. 9A to 9D in FIG. 9 show inter-module result lists, which express results in combinations of modules having dependences in a table format, and are configured by the same rows/columns as in the compatibility table shown in FIG. 7 above. 9A in FIG. 9 shows an inter-module result list, which stores test results in combinations of all compatible versions in the compatibility table of 8A in FIG. 8, which is referred to by the label “L:1-2” between “Unit Controller-A” and “Unit-A1” having the dependence. Likewise, 9B in FIG. 9 shows an inter-module result list, which stores test results in combinations of all compatible versions in the compatibility table of 8B in FIG. 8, which is referred to by the label “L:1-3”. Likewise, 9C in FIG. 9 shows an inter-module result list, which stores test results in combinations of all compatible versions in the compatibility table of 8C in FIG. 8, which is referred to by the label “L:1-4”. Likewise, 9D in FIG. 9 shows an inter-module result list, which stores test results in combinations of all compatible versions in the compatibility table of 8D in FIG. 8, which is referred to by the label “L:4-5”. Respective fields of the inter-module result lists in 9A to 9D in FIG. 9 store labels to a test result list in combinations of the modules of the corresponding versions. In the inter-module result list, when a version or unit ID of a module-i is present in an m-row and that of a module-j is present in an n-row, a test result of this combination is referred to by a label “TST:i-j-m-n”. For example, 9C in FIG. 9 shows test results in combinations of respective versions of “Unit Controller-A” and “Soft-1” referred to by the label “L:1-4”. Since a version v1.01 of “Unit Controller-A” corresponds to the second row, and a version v1.00 of “Soft-1” corresponds to the first column, a test result in a combination of these versions can be referred to by a label “TST:1-4-2-1”. Of course, since no result in an incompatible combination is present, “x” is described in the corresponding field.

FIG. 10 shows a test result list referred to by the labels “TST:i-j-m-n” to the test results in 9A to 9D in FIG. 9, pieces of date information are enumerated in columns, and all the labels “TST:i-j-m-n” to be referred to in 9A to 9D in FIG. 9 are enumerated in rows. Respective fields record test results in combinations of modules of the corresponding versions. Every time new results are input, a column as date information is added, and test results are recorded in the respective fields. For example, the second row in FIG. 10 is a label “TST:1-2-1-1”, and as can be seen from FIG. 9, fields corresponding to this row record results in a combination of the version v1.00 of “Unit Controller-A” and a unit ID a1-20-10 of “Unit-A1”. It is confirmed from the label “TST:1-2-1-1” in FIG. 10 that a test result on Jan. 6, 2008 was OK. Each field records OK or NG as a test result if a corresponding test result is available on that date. However, when no test is carried out, “-” is described in a field. The reason why labels “TST:i-j-m-0” including a last number “0”, which are not present in 9A to 9D in FIG. 9 are included in rows of FIG. 10 is to include not only results of combinations of modules but also test results of modules-i alone. For example, the second row of FIG. 10 is a label “TST:1-2-1-0”, which represents a test result of the version v1.00 of “Unit Controller-A” alone from 9A in FIG. 9. The result confirmation program confirms based on the result information stored in the third storage unit 503 whether or not there are previous results in all modules themselves or combinations between a plurality of modules having dependences, and determines whether or not to update control information. Thus, upon updating control information, the consistency confirmation program performs consistency confirmation by collation with consistency program, and can determine the advisability of upgrading. Furthermore, the result confirmation program confirms a result in a case example in which identical control information was previously applied, and can determine the advisability of upgrading more reliably.

The updating unit 4, the exposure apparatus 1, the control unit 303 of the exposure apparatus 1, and the determination unit 5 have been described. As described above, each unit controller 403 included in the control unit 303 acquires unit IDs from one or more units 410 to form a unit ID list, and stores it together with the versions of the unit control programs. The main control unit 401 included in the control unit 303 of the exposure apparatus 1 acquires the unit ID lists and the versions of the unit control programs from the one or more unit controllers 403, and stores them as configuration information required for consistency confirmation in the second storage unit 304. On the other hand, the determination unit 5 stores inter-module consistency information and result information in the third storage unit 503 in advance. Furthermore, the determination unit 5 collates configuration information acquired from the control unit 303 of the exposure apparatus 1 with the consistency information using the consistency confirmation program. Moreover, the determination unit 5 collates previous result information using the result confirmation program. In this manner, the advisability of upgrading can be surely determined.

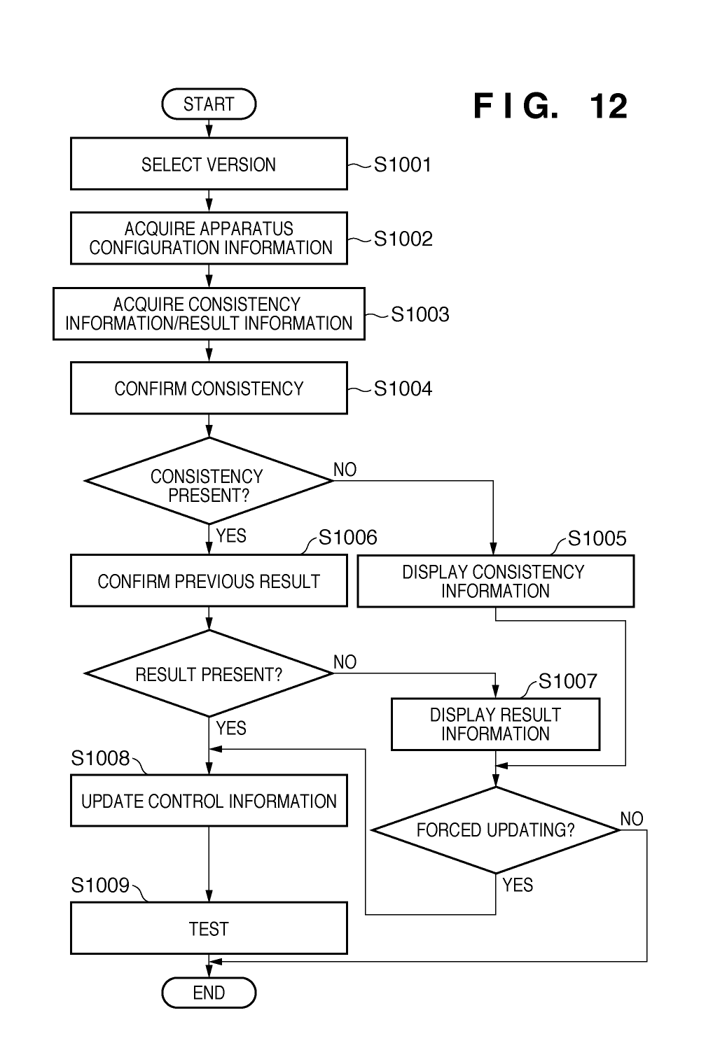

The exposure apparatus 1 which mounts two stages that hold substrates as an example of the exposure unit shown in FIG. 3 will be described below. FIG. 11 is a diagram of the exposure apparatus 1. The exposure apparatus 1 includes a measurement station 601 and exposure station 602. The exposure station 602 supports a reticle stage 604 that supports a reticle 603, and substrates 605 (substrates 605a and 605b). Furthermore, the exposure station 602 includes two substrate stages 606 (stages 606a and 606b) which are movable between the two stations, and a top board 607 which supports the two substrate stages 606. The exposure apparatus 1 includes an illumination optical system 608 which illuminates the reticle 603 supported by the reticle stage 604 with exposure light, and a projection optical system 609 which projects and exposes a pattern of the reticle 603 illuminated with the exposure light on the substrate 605a on the substrate stage 606. Note that the two substrate stages 606 are arranged in this embodiment, but the present invention is applied to an exposure apparatus having one or two or more substrate stages 606. A case will be exemplified below wherein a scan type exposure apparatus (scanner) which exposes a pattern formed on the reticle 603 on the substrate 605 while synchronously moving the reticle 603 and substrate 605 each other in a scan direction is used as the exposure apparatus 1. Of course, the exposure apparatus 1 may be a cell projection exposure apparatus (stepper). In the following description, assume that a direction which agrees with the optical axis of the projection optical system 609 is defined as a Z-axis direction, a synchronous moving direction (scan direction) of the reticle 603 and substrate 605 in a plane perpendicular to the Z-axis direction is defined as a Y-axis direction, and a direction (non-scan direction) perpendicular to the Z-axis direction and Y-axis direction is defined as an X-axis direction. Also, assume that directions about the X-, Y-, and Z-axes are respectively defined as θX, θY, and θZ directions.

A predetermined illumination region on the reticle 603 is illuminated with exposure light having a uniform illuminance distribution by the illumination optical system 608. The exposure light emitted from the illumination optical system 608 generally uses mercury lamp light, KrF excimer laser beam, ArF excimer laser beam, F2 laser beam, or Extreme Ultra Violet (EUV) light. However, the present invention is not limited to these exposure light beams. The reticle stage 604 supports the reticle 603, and can make a two-dimensional movement in a plane perpendicular to the optical axis of the projection optical system 609, that is, an XY plane, and a minute rotation about the θZ direction. The reticle stage 604 is driven by a driving device (not shown) such as a linear motor, and the driving device of the reticle stage is controlled by the control unit 303 of the exposure apparatus 1 shown in FIG. 3. A mirror is arranged on the reticle stage 604. Also, a laser interferometer (not shown) is arranged at a position opposing the mirror. The laser interferometer measures a position in the two-dimensional direction in the XY plane and a rotation angle θZ of the reticle 603 on the reticle stage 604 in real time, and outputs the measurement results to the control unit 303 of the exposure apparatus 1. The control unit 303 of the exposure apparatus 1 aligns the reticle 603 supported by the reticle stage 604 by driving the driving device of the reticle stage based on the measurement results of the laser interferometer. The projection optical system 609 projects and exposes a pattern on the reticle 603 on the substrate 605 at a predetermined projection magnification β. The projection optical system 609 includes a plurality of optical elements, which are supported by a lens barrel as a metal member. In this embodiment, the projection optical system 609 is a reduction projection system having, for example, the projection magnification β=¼ or ⅕.

Each substrate stage 606 supports the substrate 605, and includes a Z stage which holds the substrate 605 via a substrate chuck, an XY stage which supports the Z stage, and a base which supports the XY stage. The substrate stage 606 is driven by a driving device (not shown) such as a linear motor. The driving device of the substrate stage is controlled by the control unit 303 of the exposure apparatus 1. On the substrate stage 606, a mirror which moves together with the substrate stage 606 is arranged. A laser interferometer (not shown) is arranged at a position facing the mirror. The laser interferometer measures the position in the XY direction and θZ of the substrate stage 606 in real time, and outputs the measurement results to the control unit 303 of the exposure apparatus 1. Also, the laser interferometer measures the position in the Z direction, and θX and θY of the substrate stage 606 in real time, and outputs the measurement results to the control unit 303 of the exposure apparatus 1. Since XYZ stages are driven based on the measurement results of the laser interferometer via the driving device of the substrate stage 606, the position in XYZ directions are adjusted, thus aligning the substrate 605 supported by the substrate stage 606. A reticle alignment detection system (not shown) is arranged in the vicinity of the reticle stage 604. The reticle alignment detection system detects reticle reference marks 610 laid out on the reticle stage 604 and stage reference marks 611 (marks 611a and 611b) on the substrate stage 606 via the projection optical system 609. Using this reticle alignment detection system, the stage reference marks 611 are aligned to the reticle reference marks 610.

The measurement station 601 includes a substrate alignment detection system 613. The substrate alignment detection system 613 includes a focus detection system 612 which detects position information (position information and tilt information in the Z-axis direction) of the surface of the substrate 605, and an alignment detection system which detects the positions of the substrate 605 and stage reference marks 611. The focus detection system 612 includes a projection system which projects detection light onto the surface of the substrate 605, and a light-receiving system which receives reflected light from the substrate 605. The detection result (measurement value) of the focus detection system 612 is output to the control unit 303 of the exposure apparatus 1. The control unit 303 of the exposure apparatus 1 drives the Z stage based on the detection result of the focus detection system 612 to adjust the position in the Z-axis direction (focus position) and tilt angle of the substrate 605 held on the Z stage. The position detection results (measurement values) of the substrate 605 and stage reference marks 611 by the substrate alignment system 613 are output as alignment position information within coordinates specified by the laser interferometer to the control unit 303 of the exposure apparatus 1. The stage reference marks 611 are set at levels nearly flush with the surface of the substrate 605, and are used to detect the positions by the reticle alignment detection system and substrate alignment detection system 613, as shown in FIG. 4. Each stage reference mark 611 also has a portion whose surface is nearly flat, and serves as a reference plane of the focus detection system 612. The stage reference marks 611 may be laid out on a plurality of corners of the substrate stage 606. The substrate 605 includes substrate alignment marks to be detected by the substrate alignment detection system 613. Assume that the substrate 605 includes a plurality of substrate alignment marks near respective shot regions on it, and the positional relationship (XY direction) between the substrate alignment marks and shot regions is given. The exposure apparatus 1 which mounts the two substrate stages performs exchange and measurement processes of a second substrate 605 on the substrate stage 606 in the measurement station 601 during, for example, an exposure process of a first substrate 605 on the substrate stage 606 in the exposure station 602. Upon completion of the respective processes, the substrate stage 606 in the exposure station 602 moves to the measurement station 601, and that in the measurement station 601 moves to the exposure station 602 parallel to the former movement, thus applying an exposure process to the second substrate 605.

An exposure method according to this embodiment will be described below. After the substrate 605 is carried into the measurement station 601, the substrate alignment detection system 613 detects the stage reference mark 611. For this purpose, the control unit 303 of the exposure apparatus 1 moves the substrate stages 606 while monitoring the output from the laser interferometer, so as to locate the optical axis of the substrate alignment detection system 613 on the stage reference mark 611. Thus, the substrate alignment detection system 613 measures the position information of the stage reference mark 611 within a coordinate system specified by the laser interferometer. Likewise, in the measurement station 601, the focus detection system 612 detects the position information of the surface of the stage reference mark 611.

Next, the positions of shot regions of the substrate 605 are detected. The control unit 303 of the exposure apparatus 1 moves the substrate stage 606 while monitoring the output from the laser interferometer, so that the optical axis of the substrate alignment detection system 613 travels on the substrate alignment marks located around respective shot regions of the substrate 605. During this movement, the substrate alignment detection system 613 detects the plurality of substrate alignment marks formed around the shot regions of the substrate 605. Then, the position of each substrate alignment mark is detected within the coordinate system specified by the laser interferometer. The positional relationship between the stage reference mark 611 and respective substrate alignment marks is calculated based on the detection results of the stage reference mark 611 and the respective substrate alignment marks by the substrate alignment detection system 613. Since the positional relationships between the respective substrate alignment marks and shot regions are respectively given, the positional relationships between the stage reference mark 611 and the shot regions on the substrate 605 within the XY plane are respectively decided.

Next, the focus detection system 612 detects the position information of the surface of the substrate 605 for each of all the shot regions on the substrate 605. The detection result is stored in the control unit 303 of the exposure apparatus 1 in association with the position in the XY direction within the coordinate system specified by the laser interferometer. The positional relationships between the surface of the stage reference mark 611 and the respective shot region surfaces on the substrate 605 are decided based on the detection results of the position information of the surface of the stage reference mark 611 and the pieces of position information of all the shot region surfaces on the substrate 605 by the focus detection system 612. The exposure station 602 performs an exposure process based on the measurement process results of the substrate 605 measured by the measurement station 601. The control unit 303 of the exposure apparatus 1 moves the substrate stage 606 so as to detect the stage reference mark 611 using the reticle alignment detection system.

The reticle alignment detection system detects the reticle reference mark 610 and stage reference mark 611 via the via the projection optical system 609. That is, the relationships in the XY and Z directions between the reticle reference mark 610 and stage reference mark 611 are detected via the projection optical system 609. As a result, the position of a reticle pattern image to be projected by the projection optical system 609 onto the substrate 605 is detected using the stage reference mark 611 via the projection optical system 609. Upon completion of detection of the position of the reticle pattern image formed by the projection optical system 609, the control unit 303 of the exposure apparatus 1 moves the substrate stage 606 to move each shot region on the substrate 605 to a position under the projection optical system 609, so as to expose each shot region on the substrate 605. Then, each shot region on the substrate 605 is scanned and exposed using the respective measurement results obtained by the measurement station 601. During exposure, each shot region on the substrate 605 is aligned with the reticle 603. In this case, alignment is done based on the positional relationships between the substrate reference mark 611 and respective shot regions calculated by the measurement station 601, and the projection position relationship between the stage reference mark 611 and reticle pattern image calculated by the exposure station 602. Also, during scan-exposure, the positional relationship between the surface of the substrate 605 and the reticle pattern image plane projected by the projection optical system 609 is adjusted. This adjustment is done based on the positional relationship between the surface of the stage reference mark 611 and that of the substrate 605 calculated by the measurement station 601, and the positional relationship between the surface of the stage reference mark 611 and the reticle pattern image plane formed by the projection optical system 609 calculated by the exposure station 602.

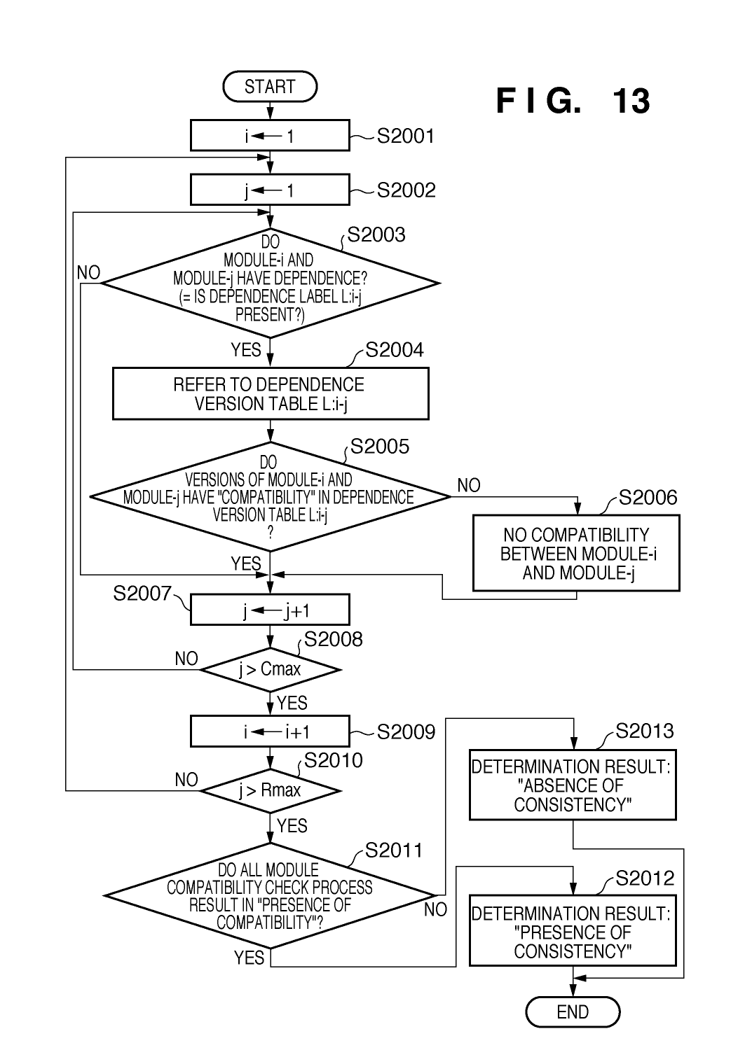

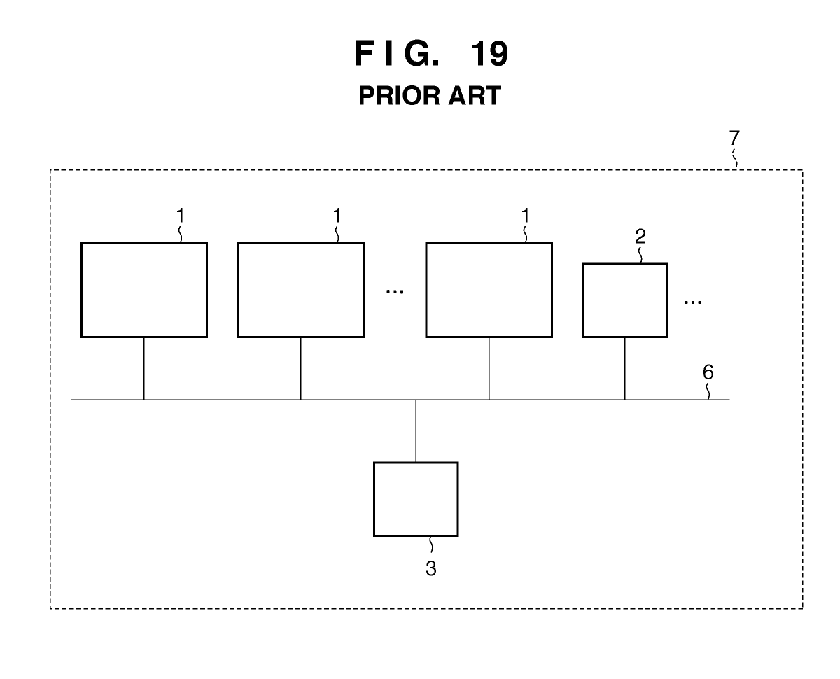

A method of updating control information of the exposure apparatus in the system including the exposure apparatus described so far will be described below with reference to the flowchart shown in FIG. 12. Note that since a pre-checking process, exposure process stop process, and exposure process start process in this example are the same as those with the same names, which have been explained in the related art using FIG. 18, the flowchart of FIG. 12 shows only update and test processes of control information to which the present invention is applied. In step S1001 in FIG. 12, an operator selects a version to update control information of the exposure apparatus 1 in the updating unit 4. At this time, a version list of software modules included in the selected control information is transmitted to the determination unit 5 via the first communication unit 202. In step S1002, configuration information required for consistency confirmation associated with updating of the control information in the exposure apparatus 1 is acquired. As described above, each unit controller 403 included in the control unit 303 of the exposure apparatus 1 acquires unit IDs from the one or more units 410 to form a unit ID list, and stores that list together with the versions of the unit control programs. Furthermore, the main control unit 401 included in the control unit 303 of the exposure apparatus 1 acquires the unit ID lists and the versions of the unit control programs from the one or more unit controllers 403, and stores them in the second storage unit 304 as configuration information required for consistency confirmation. Note that the data structure of the configuration information has the format shown in FIG. 5, as described in the description of the control unit 303 of the exposure apparatus 1. In step S1003 in FIG. 12, the determination unit 5 acquires the configuration information from the exposure apparatus 1 via the third communication unit 502. Furthermore, the determination unit 5 acquires inter-module consistency information and result information from the third storage unit 503. Note that the consistency information is configured as a compatibility table including pairs of compatible versions (or unit IDs) between modules having dependences, as described in the description of the determination unit 5. Note that the data structure of the consistency information is configured by the inter-module dependence list shown in FIG. 7 and the compatibility tables shown in 8A to 8D in FIG. 8. Also, the result information indicates test results in case examples in which control information to be updated was previously applied, and operation logs periodically acquired after operations. As the result information, test results and operation logs for respective software modules are stored in the third storage unit 503 as sets together with information of the versions or unit IDs. Furthermore, as the result information, when modules have a dependence between them, test results and operation logs in that combination are stored in the third storage unit 503 as a set together with consistency information. Note that the data structure of the result information is configured by the inter-module result lists shown in 9A to 9D in FIG. 9 and the test result list shown in FIG. 10.

In step S1004 in FIG. 12, the consistency confirmation program confirms consistencies between the configuration information acquired in step S1002 and the version list of software modules included in the control information based on the consistency information acquired in step S1003. More specifically, the program confirms consistencies between all modules having dependences based on the inter-module dependence list with reference to the corresponding versions or unit IDs from the configuration information and version list.

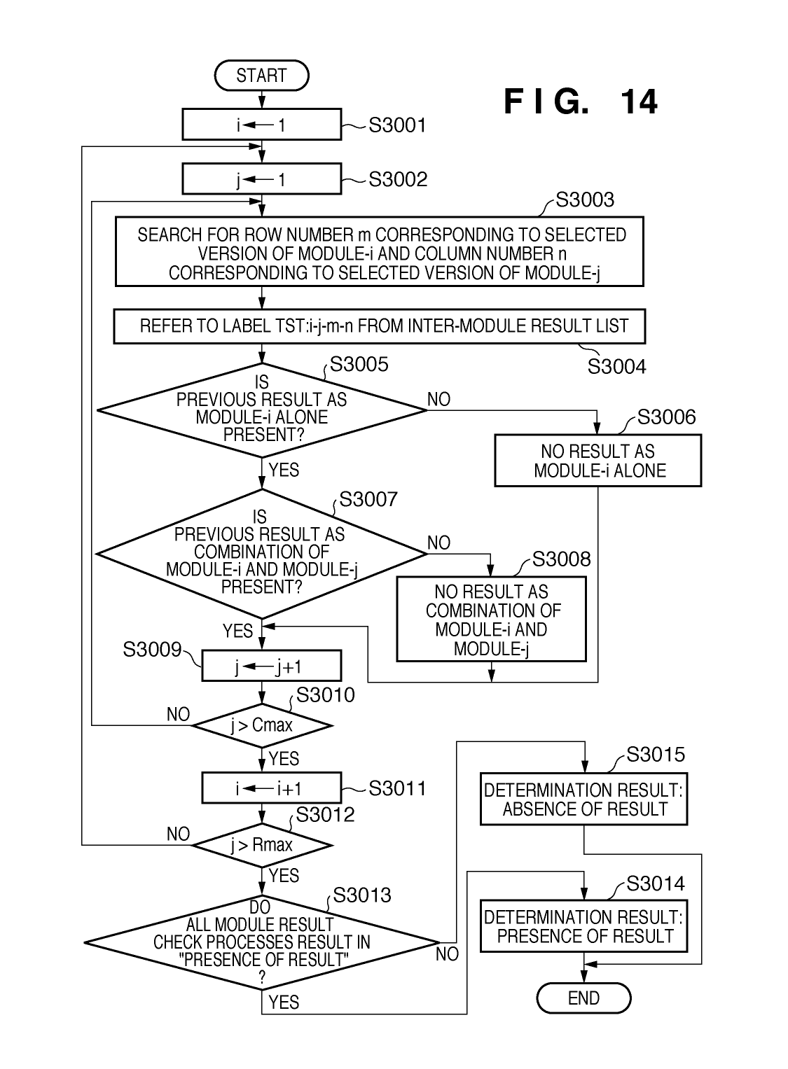

FIG. 13 is a flowchart showing the sequence of a subroutine of the consistency confirmation process in step S1004 in FIG. 12. In steps S2001 and S2002, values of a reference row number i and reference column number j of the inter-module dependence list are respectively initialized to “1”. In step S2003, a field specified by the i-row and j-column of the inter-module dependence list shown in FIG. 7 is referred to so as to confirm whether or not there is a dependence between a module-i and module-j by checking the presence/absence of a label “L:i-j”. If no label “L:i-j” is found, that is, “the absence of dependence” is determined in step S2003, the process skips to step S2007. If the label “L:i-j” is found, that is, “the presence of dependence” is determined in step S2003, the process advances to step S2004. In step S2004, the consistency confirmation program acquires versions of the module-i and module-j from the version list of the selected control information to be updated and the configuration information list. Then, the consistency confirmation program confirms the presence/absence of compatibility between the module-i and module-j from the compatibility tables “L:i-j” shown in 8A to 8D in FIG. 8. More specifically, the program refers to the version or unit ID of the module-i from the version list (in case of a module to be updated) or the configuration information list first. Likewise, the program refers to the version or unit ID of the module-j. Finally, the program refers to the contents of a field specified by the column and row values of the compatibility version module table “L:i-j” as the versions or unit IDs of the module-i and module-j. If the referred value is ◯ in step S2005, that is, if “the presence of compatibility” is determined, the process advances to step S2007 to increment the reference column number j of the inter-module dependence list shown in FIG. 7 by “+1”. Conversely, if the referred value is x in step S2005, that is, if the absence of compatibility is determined, the process advances to step S2006. Then, a pair of the module names determined as the absence of compatibility and their versions or unit IDs are stored, and the process then advances to step S2007. If the reference column number j does not exceed the number Cmax of columns in step S2008, the process returns to step S2003; if the reference column number j exceeds the number Cmax of columns, the process advances to step S2009. In step S2009, the reference row number i of the inter-module dependence list shown in FIG. 7 is incremented by “+1”. If the reference row number i does not exceed Rmax in step S2010, the process returns to step S2002; if the reference row number i exceeds Rmax in step S2010, the process advances to step S2011. With the processes in steps S2001 to S2010 described above, the presence/absence of dependence can be checked in all combinations of modules, and a compatibility of the versions or unit IDs can be checked in all combinations of modules having dependences. If “the absence of compatibility” is determined in step S2005 and step S2006 is executed even once, the process advances to step S2013 to determine “the absence of consistency”, and step S1004 in FIG. 12 ends as “the absence of consistency”. If “the absence of compatibility” is not determined even once in step S2005, and step S2006 is not executed, the process advances to step S2011 to determine “the presence of consistency”, and the consistency confirmation process in step S1004 in FIG. 12 ends as “the presence of consistency”. Then, in step S1006 the result confirmation program refers to the acquired result information to confirm whether or not previous results are available for all software modules to be updated. Furthermore, when there is a dependence between modules, the program confirms whether or not previous results are available for that combination, and determines “the presence of result” if results are available.

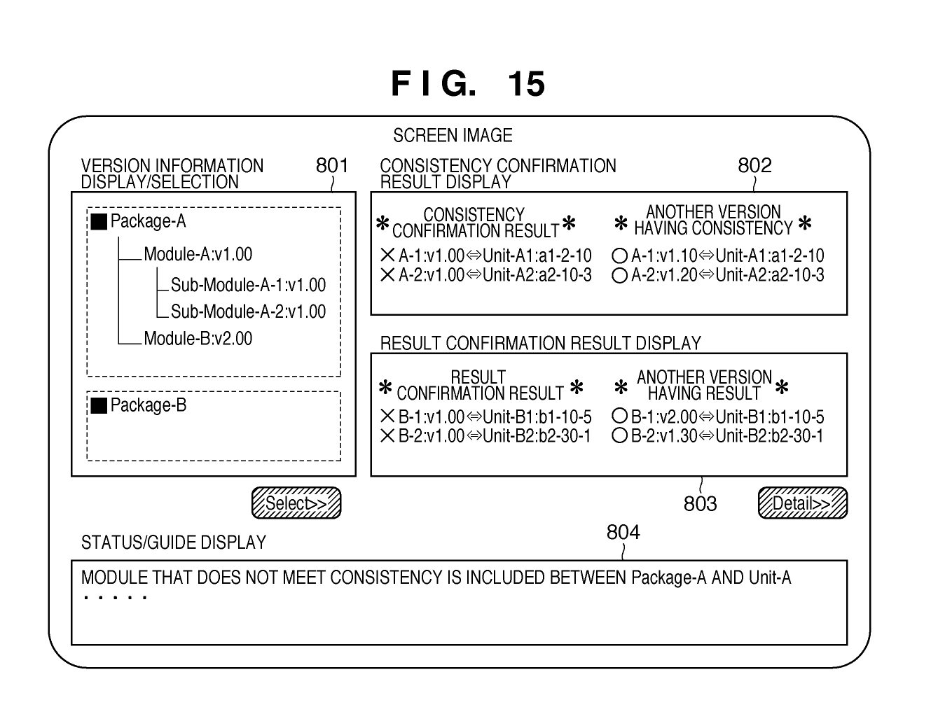

FIG. 14 is a flowchart showing the sequence of the result confirmation process in step S1006 in FIG. 12. As shown in FIG. 14, in steps S3001 and S3002 the values of a reference row number i and reference column number j of the inter-module dependence list are respectively initialized to “1”. In step S3003, the inter-module result lists shown in 9A to 9D in FIG. 9 are referred to so as to search for a row number m corresponding to the version or unit ID of the selected module-i and a column number n corresponding to the version or unit ID of the selected module-j. In step S3004, a label “TST:i-j-m-n” is read out from the corresponding field. In step S3005, rows of labels “TST:i-j-m-0” in the test result list in FIG. 10 are referred to so as to check all test results recorded for respective columns and dates as the results of the module-i alone. If at least one “OK” field is found, “the presence of result” is determined, and the process advances to step S3007. If no “OK” field is found, “the absence of result” is determined, and the process advances to step S3006. After the module name and the version or unit ID are stored, the process skips to step S3009. According to a result determination policy, when an “NG” field is found, “the absence of result” may be determined. In step S3007, rows of the labels “TST:i-j-m-n” in the test result list in FIG. 10 are referred to, so as to confirm results in a combination of the selected version or unit ID of the module-i and that of the module-j. The rows of the labels “TST:i-j-m-n” in the test result list in FIG. 10 are referred to, so as to check all test results recorded for respective columns and dates. If at least one “OK” field is found, “the presence of result” is determined, and the process advances to step S3009. Conversely, if no “OK” field is found, “the absence of result” is determined, and the process advances to step S3008. After the pair of module names determined as the absence of result and their versions or unit IDs are stored, the process advances to step S3009. According to a result determination policy, when an “NG” field is found, “the absence of result” may be determined. In step S3009, the reference column number j of the inter-module result lists shown in 9A to 9D in FIG. 9 is incremented by “+1”. If the reference column number j does not exceed the number Cmax of columns in step S3010, the process returns to step S3003; if the reference column number j exceeds the number Cmax of columns, the process advances to step S3011. In step S3011, the reference row number i in the inter-module result lists shown in 9A to 9D in FIG. 9 is incremented by “+1”. If the reference row number i does not exceed Rmax in step S3012, the process returns to step S3002; if the reference row number i exceeds Rmax in step S3012, the process advances to step S3013. With the processes in steps S3001 to S3012, the presence/absence of results can be checked in combinations of all modules having dependences. If “the absence of result” is determined even once in step S3013 and step S3006 or S3008 is executed, the process advances to step S3015 to determine “the absence of result” as a result confirmation result, and the result confirmation process in step S1006 in FIG. 12 ends as “the absence of result”. If no “absence of result” is determined even once in step S3013, and step S3006 or S3008 is not executed, the process advances to step S3014 to determine “the presence of result”, and step S1006 in FIG. 12 ends as “the presence of result”.

If “the presence of consistency” is determined in step S1004 as the consistency confirmation process and “the presence of result” is determined in step S1006 as the result confirmation process, the process advances to a process of updating control information in step S1008, and the updating unit 4 starts updating of the selected control information. If “the absence of consistency” is determined in step S1004 as the consistency confirmation process, a list of modules as a basis of determination of “the absence of consistency” is output to the display unit in a process for displaying consistency information in step S1005. Furthermore, the consistency list is searched for “◯” fields indicating “the presence of consistency”, thereby searching for combinations of compatible versions or unit IDs. If other combinations of versions or unit IDs which meet consistency are available, a combination list of these versions and unit IDs is output to the display unit. If “the absence of result” is determined in step S1006 as the result confirmation process, a version list of modules as a basis of determination of the absence of result is output to the display unit in a process for displaying result information in step S1007. Furthermore, the test result list is searched for “OK” fields indicating “the presence of result”, thereby searching for combinations of versions or unit IDs having results. If other combinations of versions or unit IDs having results are available, a combination list of these versions and unit IDs is output to the display unit. Also, the determination unit 5 instructs the updating unit 4 to accept a forcing instruction which instructs to forcibly update the control information. Therefore, when the operator determines that he or she can proceed with updating of the control information with knowledge of other influence ranges in accordance with the contents of the third display unit 504, he or she can force to proceed with the update process. Upon completion of updating of the control information, all processes end via a test process in step S1009.

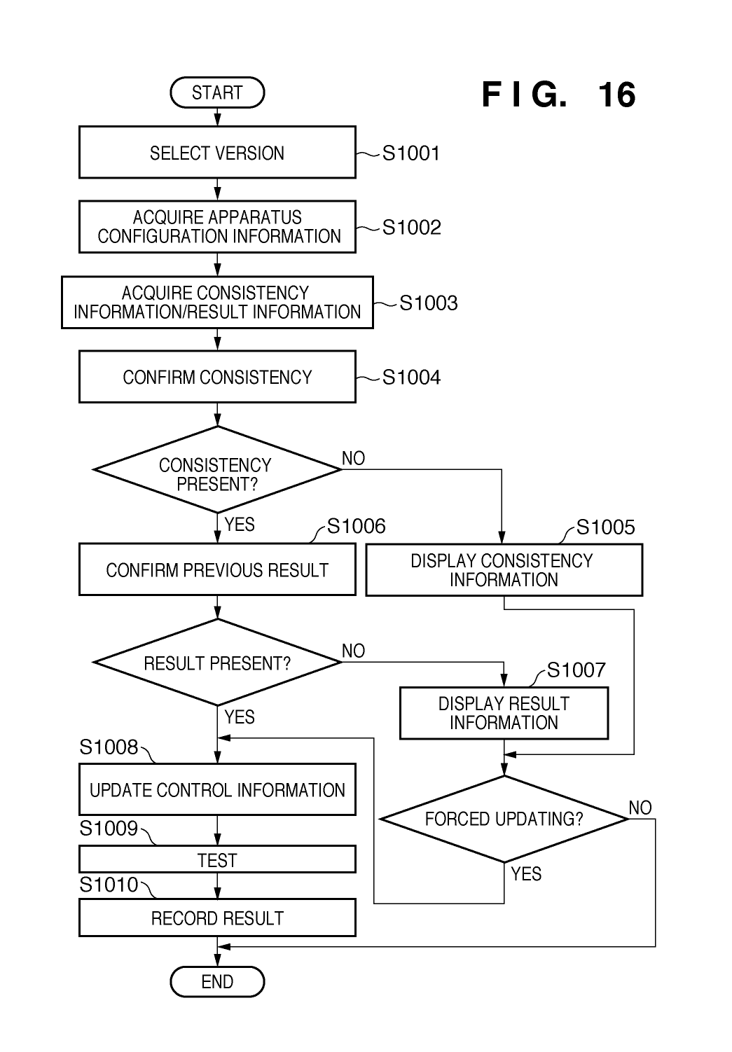

FIG. 15 shows a display example of the third display unit 504 of the determination unit 5 when the control information is to be updated. Reference numeral 801 denotes an area which displays a list of the version of control information to be updated by the updating unit 4 and the names and versions of individual software modules included in the control information. Reference numeral 802 denotes an area which displays a list of the names and versions or unit IDs of modules determined as “the absence of consistency”, and other versions having consistencies. Reference numeral 803 denotes an area which displays the names and versions or unit IDs of modules having no results or combinations of modules having no results, and a list of other versions having results. Reference numeral 804 denotes an area which displays associated information about the consistencies and results. The operator can determine based on this information whether another version is applied by aborting updating of the control information or updating of the control information is forcibly proceeded.

As described above, in the system including the exposure apparatus as an example of the manufacturing apparatus to which the present invention is applied, and the method of updating the control information of the exposure apparatus, the consistency associated with updating of the control information is confirmed. At the same time, whether or not previous results are available is further confirmed, thus allowing surer and securer upgrading. In the above example, the consistency information of the control information includes compatibility information between two versions. The consistency information may include compatibility information among a plurality of versions more than two versions to determine the consistency.

### Second Embodiment

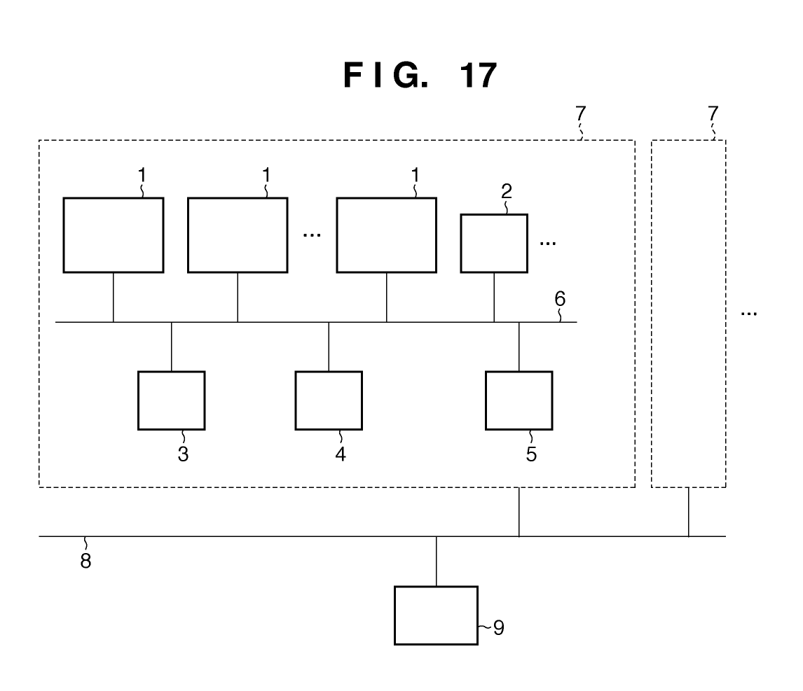

The second embodiment of a system including an exposure apparatus as an example of a manufacturing apparatus and a method of updating control information of the exposure apparatus will be described below. Note that the system of the exposure apparatus according to this embodiment is the same as that of the first embodiment described using FIG. 1, and a repetitive description thereof will not be made. The updating method of the exposure apparatus according to the second embodiment will be described below with reference to the flowchart shown in FIG. 16. Since steps S1001 to S1005, that is, the step of selecting a version, that of acquiring configuration information, that of acquiring consistency information and result information, that of confirming a consistency, and that of displaying consistency information are the same as those in the first embodiment, a description thereof will not be given. Furthermore, since steps S1006 to S1009, that is, the step of confirming results, that of displaying result information, that of updating the control information, and that of conducting a test are also the same as those in the first embodiment, a description thereof will not be given. As can be seen from FIG. 16, the updating method of the exposure apparatus of this embodiment is different from the first embodiment in that step S1010 of recording a result is added after step S1009. According to this embodiment, in step S1010 of recording a result, a determination unit 5 receives a result of a test in step S1009, which is conducted after updating of the control information, via a third communication unit 502, and stores that result as result information. Note that the new result information can be stored by adding a new row to the test result list in FIG. 10 and reflecting the result to the corresponding field. Note that storing, in advance, the test result acquired after step S1009 is not particularly limited to an exposure apparatus 1 and updating unit 4, and the determination unit 5 can store the test result if it can receive the result via the third communication unit 502.

A point that this embodiment is superior to the first embodiment will be described below. According to the second updating method of the exposure apparatus, since the result of the test conducted after updating of the control information is stored in the determination unit 5, step S1006 of confirming results at the time of updating of another exposure apparatus, which is executed later, can determine the advisability of updating based on this result information. Assume that control information is updated while “the absence of result” is determined in step S1006 of confirming results, and a normal test result can be recorded as result information in step S1010 of recording a result. In this case, “the presence of result” can be determined in step S1006 of confirming results at the time of updating of another exposure apparatus, which is executed later, and control information can be updated safer based on the previous results. Although not shown in FIG. 16, in an operation of the exposure apparatus after the control information is updated, the determination unit 5 may periodically receive operation logs from the exposure apparatus 1 via the third communication unit 502 and may record them as result information. By recording operation logs as result information, more results can be stored. Also, the determination unit 5 analyzes information indicating operation logs, and can determine based on the analysis result and another result information whether or not the exposure apparatus 1 after updating normally operates.

As described above, in the system including the exposure apparatus as an example of the manufacturing apparatus to which the present invention is applied, and the updating method of the exposure apparatus, the consistency associated with updating of the control information is confirmed, and whether or not previous results are available can also be confirmed at the same time. Since a result of a test conducted after updating of the exposure apparatus is recorded as result information, this result information can be used in determination of the advisability of updating at the time of updating of another exposure apparatus, which is executed later. Thus, surer and securer upgrading can be attained.

### Third Embodiment

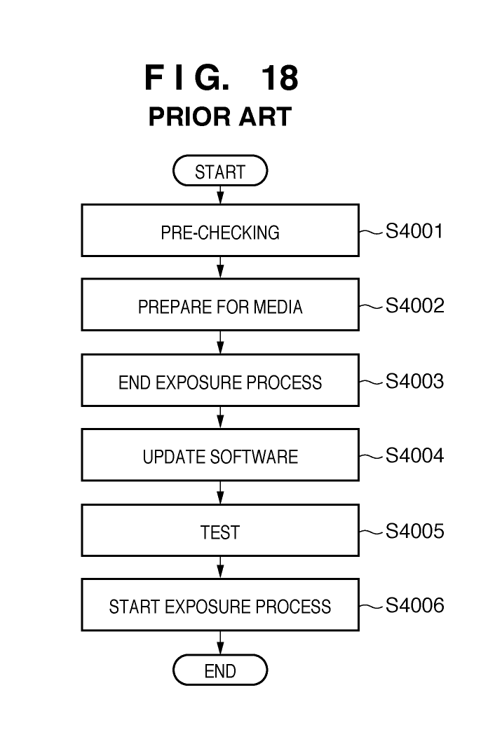

The third embodiment of a system including an exposure apparatus and a method of updating control information of the exposure apparatus will be described below with reference to FIG. 17. FIG. 17 is a diagram of a second system including an exposure apparatus to which the present invention is applied. Note that as for the updating method of the exposure apparatus of this embodiment, one of the updating method of the first embodiment described using FIG. 12 and that of the second embodiment described using FIG. 16 can be applied. Hence, a description thereof will not be repeated. Also, since exposure apparatus 1, other manufacturing apparatus 2, a controller 3 of a manufacturing plant, an updating unit 4, a determination unit 5, and a first communication network 6 of this embodiment are the same as those in the first embodiment described using FIG. 1, a description thereof will not be repeated. In this embodiment, one or more semiconductor device manufacturing plants 7 are connected, via a second communication network 8, to at least one second determination unit 9 which is installed outside the semiconductor device manufacturing plants. Note that the second determination unit 9 and one or more determination units 5 communicate with each other via the second communication network 8 to update each other's data of consistency information and result information, and share the same consistency information and result information. In this way, the consistency information and result information can be shared and managed across the plurality of semiconductor device manufacturing plants 7. The load on a manual maintenance of a database can be reduced, and the advisability of updating of control information can be determined based on more results. The second determination unit 9 stores the consistency information and result information, and each determination unit 5 makes determinations based on the consistency information and result information, thus distributing the functions of the determination unit 5 and second determination unit 9.

As described above, in the system including the exposure apparatus as an example of the manufacturing apparatus to which the present invention is applied, and the updating method of the exposure apparatus, the consistency associated with updating of the control information is confirmed, and whether or not previous results are available can also be confirmed at the same time. Furthermore, since the consistency information and result information are shared between a plurality of semiconductor device manufacturing plants and outside the semiconductor device manufacturing plant, surer and securer upgrading can be attained.

A method of manufacturing a device such as a semiconductor integrated circuit element or liquid crystal display element using the manufacturing system including the aforementioned exposure apparatus will be exemplified below.

A device is manufactured via a step of transferring a pattern onto a substrate using the exposure apparatus, a step of developing the substrate on which the pattern is transferred, and other state-of-the-art steps of processing the developed substrate. Other state-of-the-art steps include etching, resist removing, dicing, bonding, and packaging steps.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-125846, filed May 25, 2009, which is hereby incorporated by reference herein in its entirety.

What is claimed is:

1. An information processing apparatus for updating control information of a manufacturing apparatus, the apparatus comprising:
an updating unit configured to update control information installed in the manufacturing apparatus with new control information; and
a determination unit configured to execute a first determination as to whether there is a consistency between a configuration of the manufacturing apparatus and the new control information based on consistency information indicating a consistency between a configuration of a manufacturing apparatus and control information, to execute a second determination, if the first determination is not negative, as to whether the manufacturing apparatus normally operates after the new control information is installed therein, based on result information indicating a result of installing of a control information in a manufacturing apparatus, and to instruct the updating unit, if the second determination is not negative, to update the control information installed in the manufacturing apparatus with the new control information.

2. The apparatus according to claim 1, further comprising a storage unit configured to store the consistency information and the result information with respect to each of a plurality of manufacturing apparatus,
wherein the determination unit executes the first determination and the second determination based on the consistency information and the result information stored in the storage unit.

3. The apparatus according to claim 2, wherein the storage unit is configured to store, if the updating unit updates the control information, as the result information, an information of a result of a test as to whether the manufacturing apparatus normally operates after the control information is updated.

4. The apparatus according to claim 1, wherein the configuration of the manufacturing apparatus is indicated by a plurality of pieces of identification information that respectively identify a plurality of hardware components of the manufacturing apparatus.

5. The apparatus according to claim 4, wherein the identification information includes information about a state of a corresponding hardware component.

6. The apparatus according to claim 1, wherein the consistency information includes at least one of information of a consistency between softwares and information of a consistency between a software and a hardware component.

7. The apparatus according to claim 1, wherein the result information includes information indicating an operation log of the manufacturing apparatus after the control information is installed in the manufacturing apparatus, and
the determination unit is configured to execute an analysis of the information of the operation log, and to execute the second determination based on the analysis.

8. The apparatus according to claim 1, wherein the determination unit is configured, if one of the first determination and the second determination is negative, to display information of the one of the first determination and the second determination, and to instruct the updating unit to allow to accept a forcing instruction that instructs the updating unit to forcibly update the control information installed in the manufacturing apparatus with the new control information.

9. A manufacturing apparatus for transferring a pattern to a substrate, the apparatus comprising:
an information processing apparatus configured to update control information of the manufacturing apparatus,
the information processing apparatus comprising:
an updating unit configured to update control information installed in the manufacturing apparatus with new control information; and
a determination unit configured to execute a first determination as to whether there is a consistency between a configuration of the manufacturing apparatus and the new control information based on consistency information indicating a consistency between a configuration of a manufacturing apparatus and control information, to execute a second determination, if the first determination is not negative, as to whether the manufacturing apparatus normally operates after the new control information is installed therein, based on result information indicating a result of installing of a control information in a manufacturing apparatus, and to instruct the updating unit, if the second determination is not negative, to update the control information installed in the manufacturing apparatus with the new control information.

10. A method of manufacturing a device, the method comprising:
transferring a pattern to a substrate using a manufacturing apparatus; and
processing the substrate to which the pattern is transferred to manufacture the device,
the manufacturing apparatus comprising an information processing apparatus configured to update control information installed in the manufacturing apparatus,
the information processing apparatus comprising:
an updating unit configured to update control information installed in the manufacturing apparatus with new control information; and
a determination unit configured to execute a first determination as to whether there is a consistency between a configuration of the manufacturing apparatus and the new control information based on consistency information indicating a consistency between a configuration of a manufacturing apparatus and control information, to execute a second determination, if the first determination is not negative, as to whether the manufacturing apparatus normally operates after the new control information is installed therein, based on result information indicating a result of installing of a control information in a manufacturing apparatus, and to instruct the updating unit, if the second determination is not negative, to update the control information installed in the manufacturing apparatus with the new control information.

11. An apparatus for updating control information of a manufacturing apparatus, the apparatus comprising:
a storage configured to store consistency information indicating a consistency between a configuration of a manufacturing apparatus and control information and result information indicating a result of installing of control information in the manufacturing apparatus in association with each other; and
a computer configured to execute, prior to updating of control information installed in the manufacturing apparatus with new control information, a determination as to whether the manufacturing apparatus which receives an instruction of the updating normally operates after the updating, based on the consistency information and the result information stored in the storage, and to update the control information installed in the manufacturing apparatus with the new control information if the determination is positive.
